(19) United States
(12) Patent Application Publication
(10) Pub. No.: US 2005/0231086 A1
(43) Pub. Date: Oct. 20, 2005

(54) System and method for supporting arc tubes in HID lamps

(76) Inventor: Jeffrey L. Johanning, Hudson, OH (US)

Correspondence Address: DUANE MORRIS LLP;SUITE 700, 1667 K STREET, N.W., WASHINGTON, DC, 20006, US

(21) Appl. No.: 11/081,709

(22) Filed: Mar. 17, 2005

Related U.S. Application Data
(62) Division of application No. 09/534,443, filed on Mar. 24, 2000.
(60) Provisional application No. 60/125,999, filed on Mar. 24, 1999.

(51) Int. Cl. H01J 1/00

(52) U.S. Cl. 313/238

(57) ABSTRACT

The present invention relates to systems and methods for mechanically supporting and electrically coupling arc tubes in high intensity discharge (“HID”) lamps. The systems and methods provide mechanical support and electrical coupling of the arc tube in an HID lamp. The electrical coupling between the electrical leads of the arc tube and the lamp base includes one or more weldless electrical connections.

### CLAIM OF PRIORITY

This application claims the priority of U.S. Provisional Patent Application Ser. No. 60/125,999 filed Mar. 24, 1999.

### BACKGROUND OF THE INVENTION

The present invention relates to systems and methods for mechanically supporting and electrically coupling arc tubes in high intensity discharge (“HID”) lamps such as metal halide lamps. More particularly, the invention relates to such systems and methods which provide mechanical support and electrical coupling of the arc tube in an HID lamp with few or no welds.

HID lamps such as metal halide lamps have found widespread acceptance in lighting large outdoor and indoor areas such as athletic stadiums, gymnasiums, warehouses, parking facilities, and the like, because of the relatively high efficiency, compact size, and low maintenance of HID lamps when compared to other lamp types. A typical HID lamp includes an arc tube which is mechanically supported within a light-transmissive outer lamp envelope. The arc tube includes two or more electrical leads which are each electrically coupled to a source of electrical power exterior of the outer lamp envelope.

In such a lamp, the mounting structure which provides mechanical support and electrical coupling for the arc tube within the outer lamp envelope includes one or more metal components which are welded for mechanical and electrical integrity. In the fabrication of such lamps, the practice of welding such components, unless automated, is labor intensive which adds expense to the fabrication process. Further, the welding of various lamp components requires numerous weld schedules for the components which may comprise different materials and geometries. Still further, the welding electrodes require a significant amount of maintenance to achieve an optimum weld. Thus the elimination of welds in the mounting structure for the arc tube is desirable to reduce the time and expense required to fabricate such lamps.

Another disadvantage of the typical HID lamp mounting structure having welds to maintain the mechanical and electrical integrity of the structure results from the susceptibility of the one or more welds in such lamps to mechanical failure during shipping of the lamps. The welds provide a relatively strong mechanical coupling of components when the weld is subjected to shear. However, the welds are relatively weak when subjected to a bending moment, which is the typical mode of mechanical failure in such lamps during shipping.

In the fabrication of HID lamps, it is important to properly position the arc tube within the outer lamp envelope so that the light center of the lamp is optimized. In the known methods of fabricating HID lamps, the various components of the arc tube mounting structure must be aligned manually by the production operator before being mechanically joined or fixtured with specialized tooling. Such an alignment process is time consuming if done manually and expensive if done using fixtures. Thus the elimination of the alignment process in the fabrication of HID lamps is desirable to reduce the time and expense required to fabricate such lamps.

Accordingly, it is an object of the present invention to provide a novel system and method for mechanically supporting and electrically coupling arc tubes in HID lamps which obviates the deficiencies of known systems and methods.

It is another object of the present invention to provide a novel system and method for mechanically supporting and electrically coupling arc tubes in HID lamps with few or no components which are welded for mechanical integrity.

It is yet another object of the present invention to provide a novel system and method for mechanically supporting and electrically coupling arc tubes in HID lamps with few or no components which are welded for electrical integrity.

It is still another object of the present invention to provide a novel system and method for mechanically supporting and electrically coupling arc tubes in HID lamps which is amenable to automation.

It is a further object of the present invention to provide a novel system and method for mechanically supporting and electrically coupling arc tubes in HID lamps which reduces mechanical failure during shipping of the lamp.

It is yet a further object of the present invention to provide a novel system and method for aligning the light center of an HID lamp.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1a is a schematic illustrating a front view of a prior art pinched body arc tube.

FIG. 1b is a schematic illustrating a front view of a prior art formed body arc tube.

FIG. 2a is a schematic illustrating a front view of a prior art mounting structure for a 400 watt metal halide lamp.

FIG. 2b is a bottom view of FIG. 2a.

FIG. 3a is a schematic illustrating a front view of a 350 watt open fixture metal halide lamp according to one aspect of the present invention.

FIG. 3b is a bottom view of FIG. 3a.

FIG. 4a is a schematic illustrating a front view of the mounting structure of the lamp illustrated in FIG. 3.

FIG. 4b is a bottom view of FIG. 4a.

FIG. 5a is a schematic illustrating one embodiment of the frame suitable for the mounting structure illustrated in FIG. 4.

FIG. 5b is a bottom view of FIG. 5a.

FIG. 5c is a section of FIG. 5b.

FIG. 6a is a schematic illustrating one embodiment of the stem clamp suitable for the mounting structure illustrated in FIG. 4.

FIG. 6b is a bottom view of FIG. 6a.

FIG. 7 is a schematic illustrating a top view of a shroud cap suitable for the mounting structure illustrated in FIG. 4.

FIGS. 8a and 8b are schematics illustrating different embodiments of the arc tube retaining tabs suitable for the shroud cap illustrated in FIG. 7.

FIG. 9a is a schematic illustrating a front view of the mounting structure illustrated in FIG. 4.

FIG. 9b is a bottom view of FIG. 9a.

FIG. 10 is a schematic illustrating one embodiment of a wire connector according to the present invention.

FIG. 11 is a schematic illustrating another embodiment of a wire connector according to the present invention.

FIG. 12 is a schematic illustrating one embodiment of the electrical coupling between the wire connectors and the stem leads according to the present invention.

FIG. 13a is a schematic illustrating a front view of a 350 watt enclosed fixture metal halide lamp according to one aspect of the present invention.

FIG. 13b is a bottom view of FIG. 13a.

FIG. 14a is a schematic illustrating a front view of the mounting structure in the lamp illustrated in FIG. 13.

FIG. 14b is a bottom view of FIG. 14a.

FIG. 15a is a schematic illustrating a front view of one embodiment of the frame suitable for the mounting structure illustrated in FIG. 14.

FIG. 15b is a bottom view of FIG. 15a.

FIG. 15c is a section of FIG. 15b.

FIG. 16a is a schematic illustrating a front view one embodiment of a stem clamp suitable for the mounting structure illustrated in FIG. 14.

FIG. 16b is a top view of FIG. 16a.

FIG. 17a is a schematic illustrating a front view of one embodiment of an arc tube clip suitable for the mounting structure illustrated in FIG. 14.

FIG. 17b is a bottom view of FIG. 17a.

FIG. 18 is a schematic illustrating a front view of one embodiment of a mounting structure suitable for a medium base lamp according to the present invention.

FIG. 19a is a schematic illustrating a side view one embodiment of a heat shield suitable for the mounting structure illustrated in FIG. 18.

FIG. 19b is a bottom view of FIG. 19a.

FIG. 20 is a schematic illustrating a bottom view of one embodiment of the frame suitable for the mounting structure illustrated in FIG. 18.

FIG. 21 is a schematic illustrating a front view of a portion of a mounting structure for a pinched body arc tube.

FIG. 22a is a schematic illustrating a side view of one embodiment of the arc tube clip suitable for the mounting structure illustrated in FIG. 21.

FIG. 22b is a bottom view of FIG. 22a.

### DESCRIPTION OF PREFERRED EMBODIMENTS

While the present invention is suitable for mechanically supporting and electrically coupling arc tubes in any type of HID lamp, it may be easily understood in the embodiment suitable for metal halide lamps.

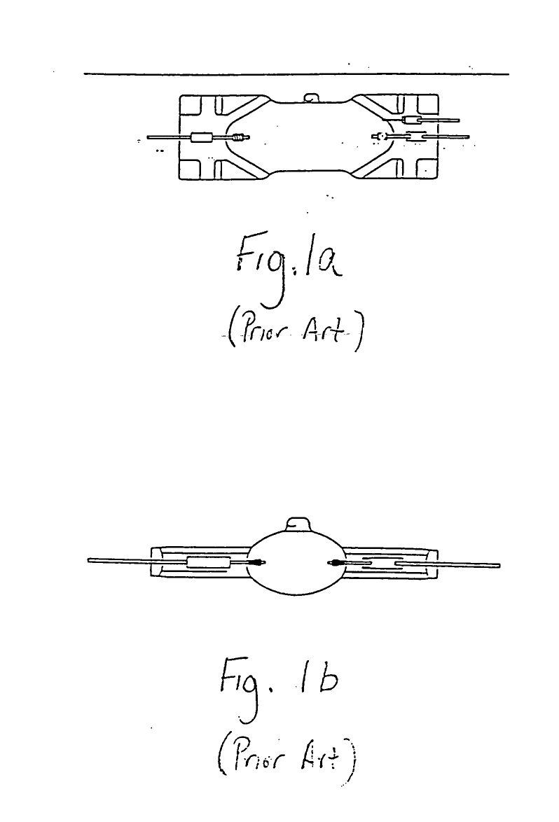

Metal halide lamps include light emitting chemicals which are hermetically sealed within an arc tube formed from light transmitting material such as quartz glass or ceramics. The arc tube may comprise a pinched body or a formed body as illustrated in FIGS. 1a and 1b respectively. The arc tube must be mechanically supported and electrically coupled within the outer lamp envelope and there are many known configurations for the arc tube mounting structure. However, there are only two basic types of arc tube mounting structures, i.e., enclosed (unshrouded) and open (shrouded). The open fixtures include a generally tubular shroud formed from light transmitting material positioned around the arc tube. The shroud provides protection in the unlikely event of a non-passive failure of the arc tube.

There are many sizes of metal halide lamps which range between about 32 watts and 2000 watts and generally include either a medium type base for lower wattage lamps (150 W or below) or a mogul type base for higher wattage lamps (175 W or greater).

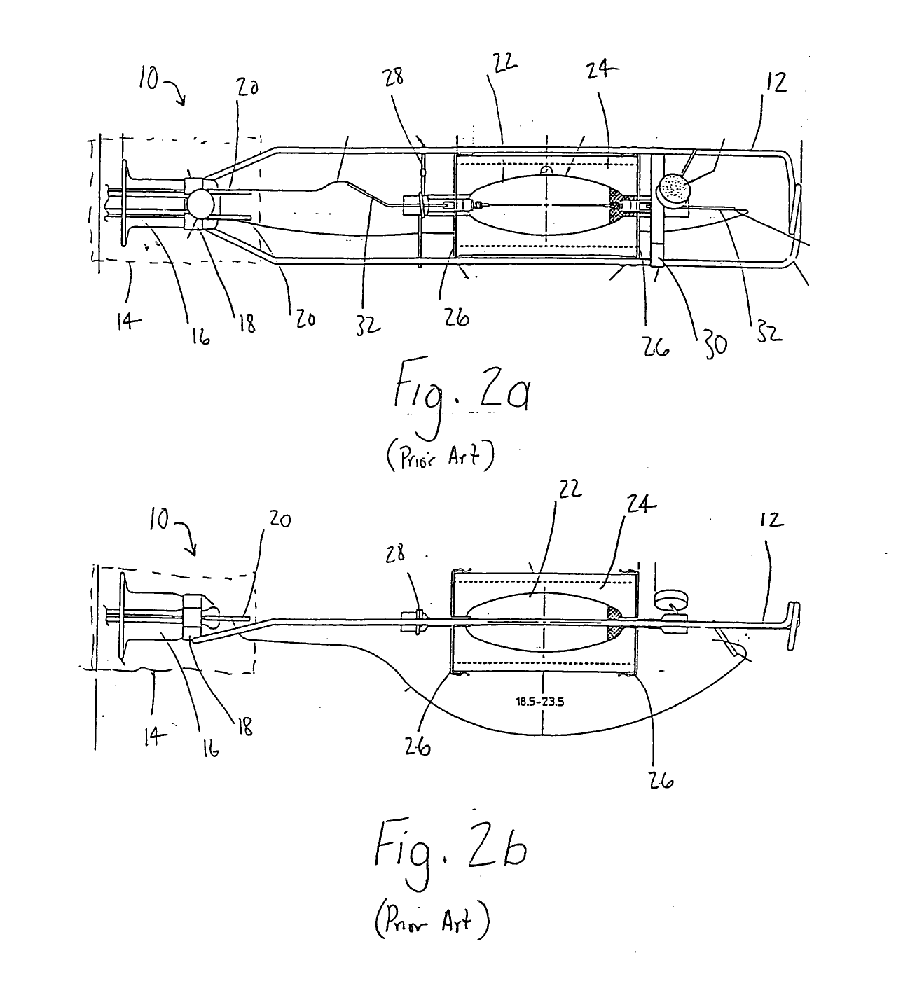

FIGS. 2a and 2b illustrate a typical prior art mounting structure for providing mechanical support and electrical coupling for a shrouded formed body arc tube in a 400 watt metal halide lamp having a mogul type base. With reference to FIGS. 2a and 2b, the arc tube mounting structure 10 includes a metal frame 12 which is mechanically supported by a stem assembly 14. The stem assembly 14 comprises a stem 16 which is typically formed from hard glass, a metallic spring clip 18, and two stem leads 20 which provide an electrical coupling between the arc tube 22 supported within the outer lamp envelope (not shown) to a source of electrical power (not shown) for operating the lamp.

The frame 12 is mechanically supported at one end by the stem assembly 14. The integrity of the mechanical support of the frame 12 by the stem assembly 14 is maintained by one or more welds between the frame 12 and the spring clip 18.

The arc tube 22 is mechanically supported at one end by an arc tube retaining clip 28 and at the other end by a strap 30. The retaining clip 28 and strap 30 are each mechanically supported from the frame 12. The integrity of the mechanical support of the retaining clip 28 and strap 30 from the frame 12 is maintained by one or more welds.

The generally tubular shroud 24 surrounds the central portion of the arc tube 22 and is mechanically supported at each end by a shroud cap 26. Each of the shroud caps 26 is mechanically supported from the frame 12. The integrity of the mechanical support of the shroud caps 26 from the frame 12 is maintained by one or more welds.

The arc tube 22 includes an arc tube lead 32 at each end. Each arc tube lead 32 is electrically coupled to one of the stem leads 20. The integrity of the electrical coupling between the arc tube leads 32 and the stem leads 20 is maintained by one or more welds.

While of utility in HID lamps of any type and wattage, the present invention may be easily understood in the embodiments suitable for mechanically supporting and electrically coupling the arc tubes of metal halide lamps.

Open Fixture Lamps:

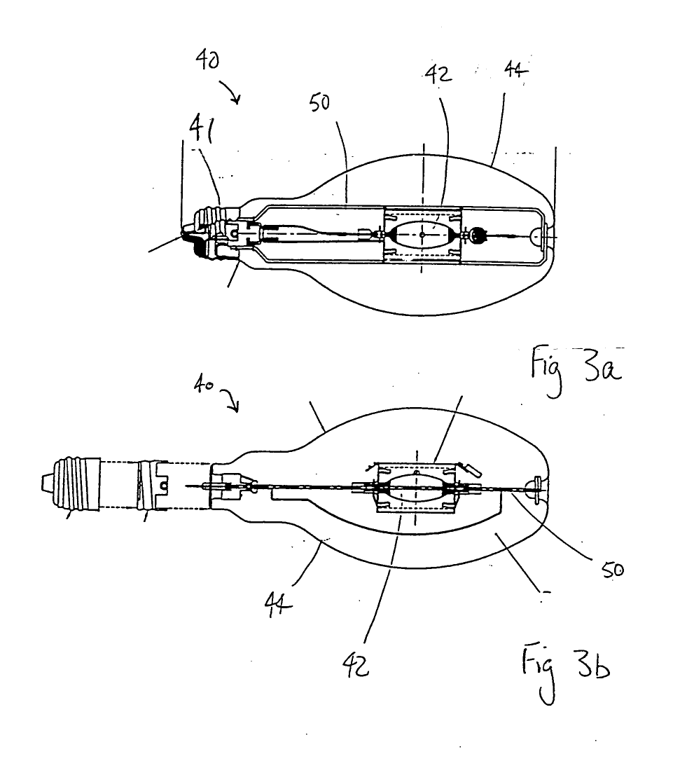

FIGS. 3a and 3b illustrate a 350 watt open fixture metal halide lamp. With reference to FIGS. 3a and 3b, the lamp 40 includes a formed body arc tube 42 which is mechanically supported and electrically coupled within the outer lamp envelope 44 by the mounting structure 50.

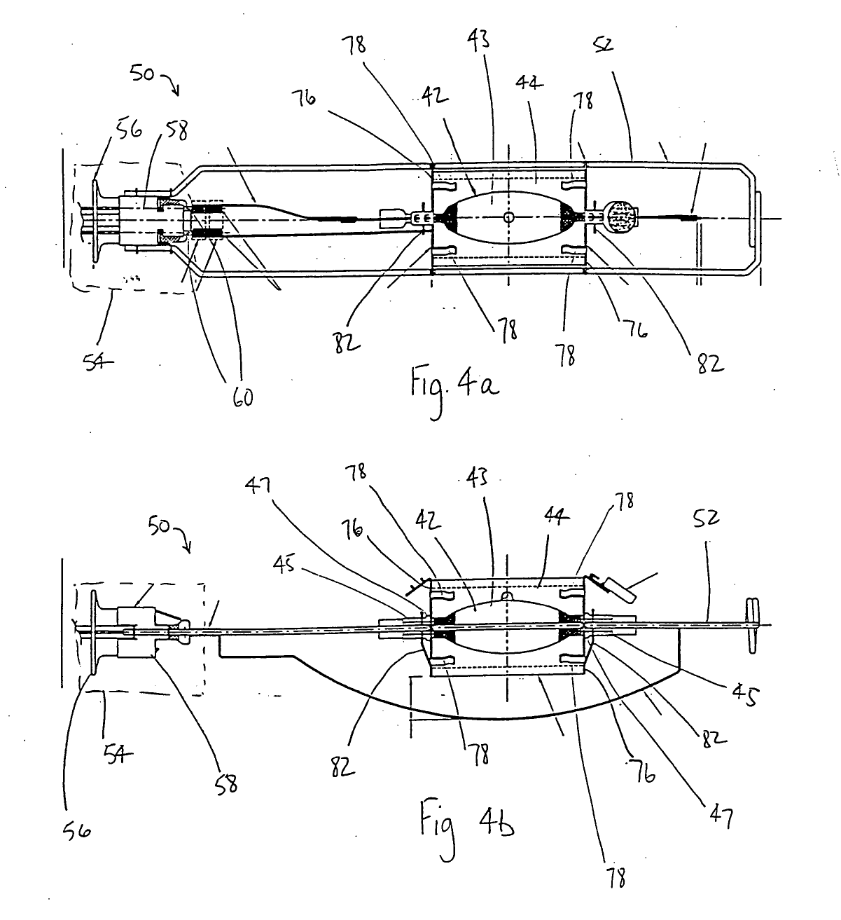

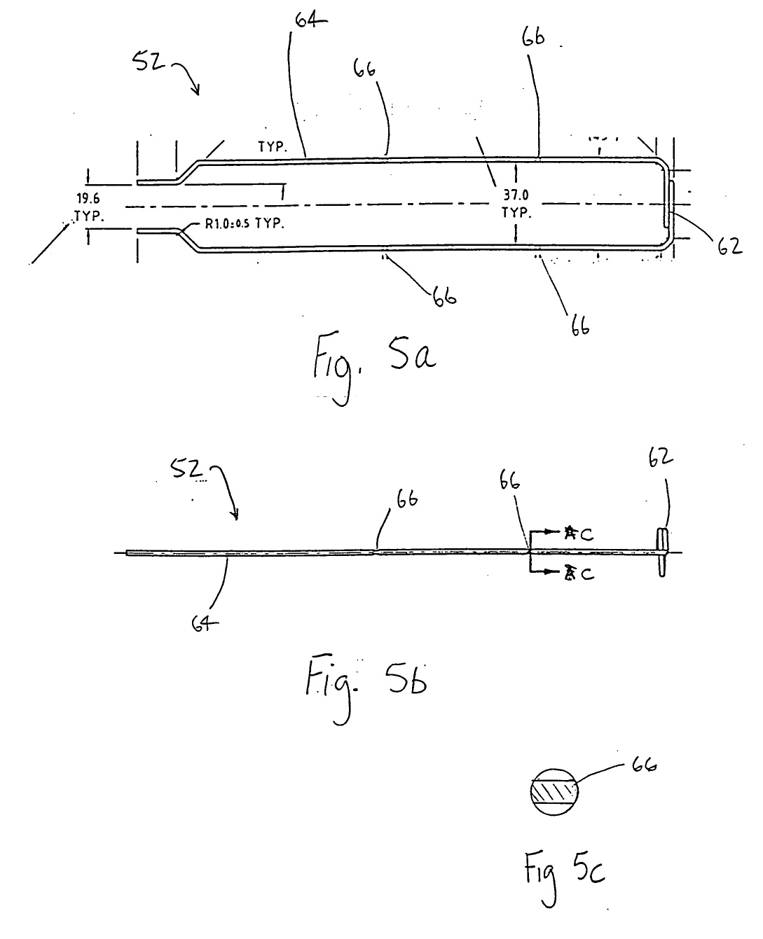

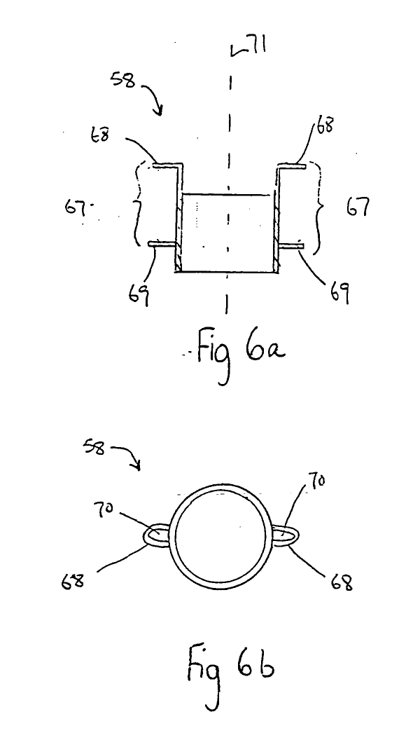

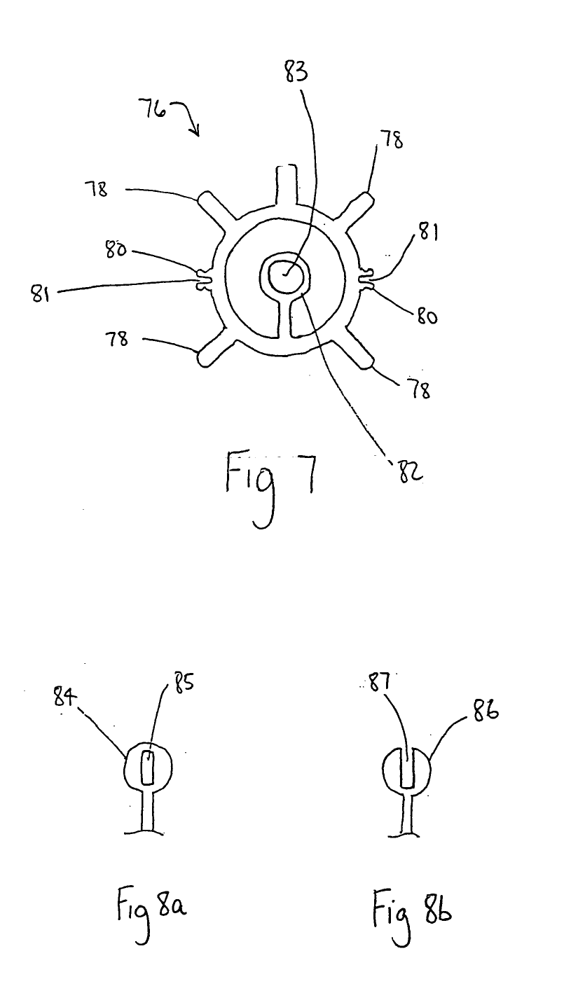

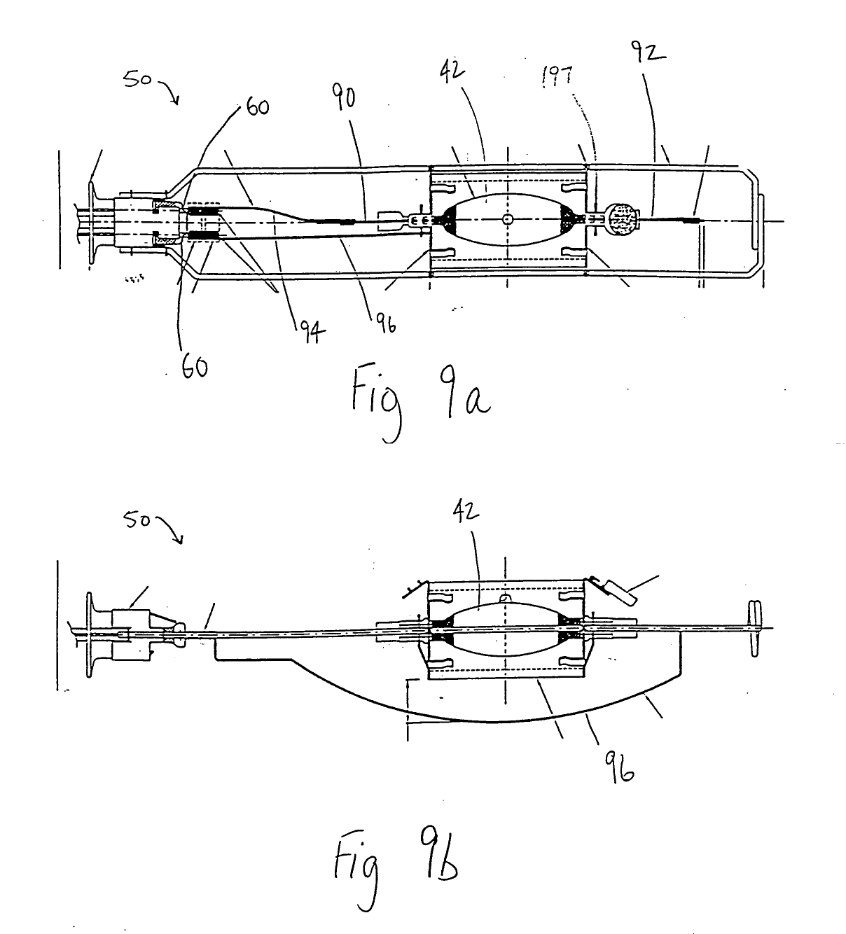

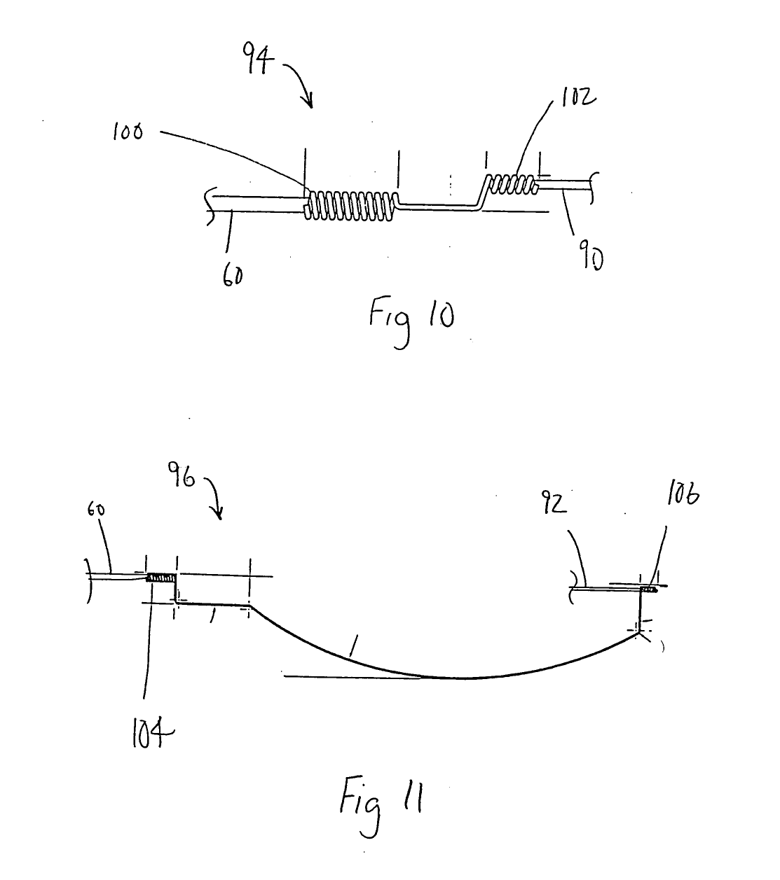

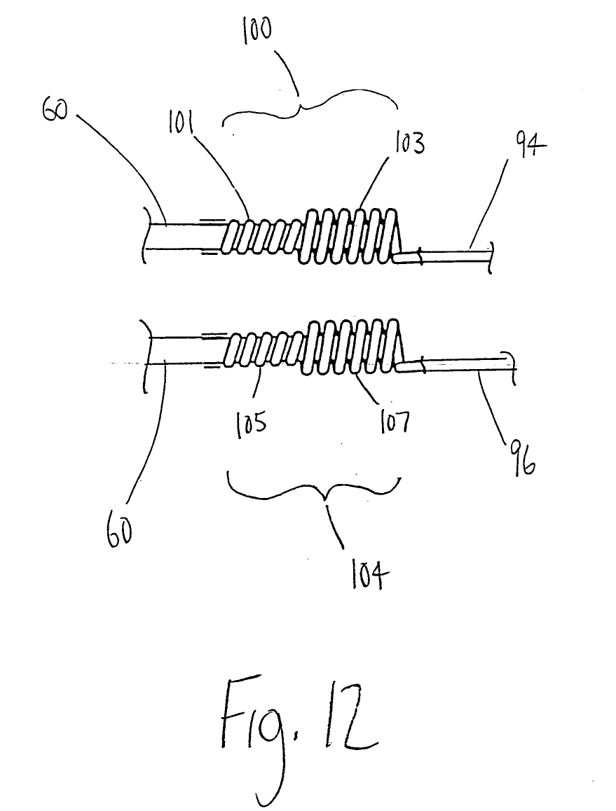

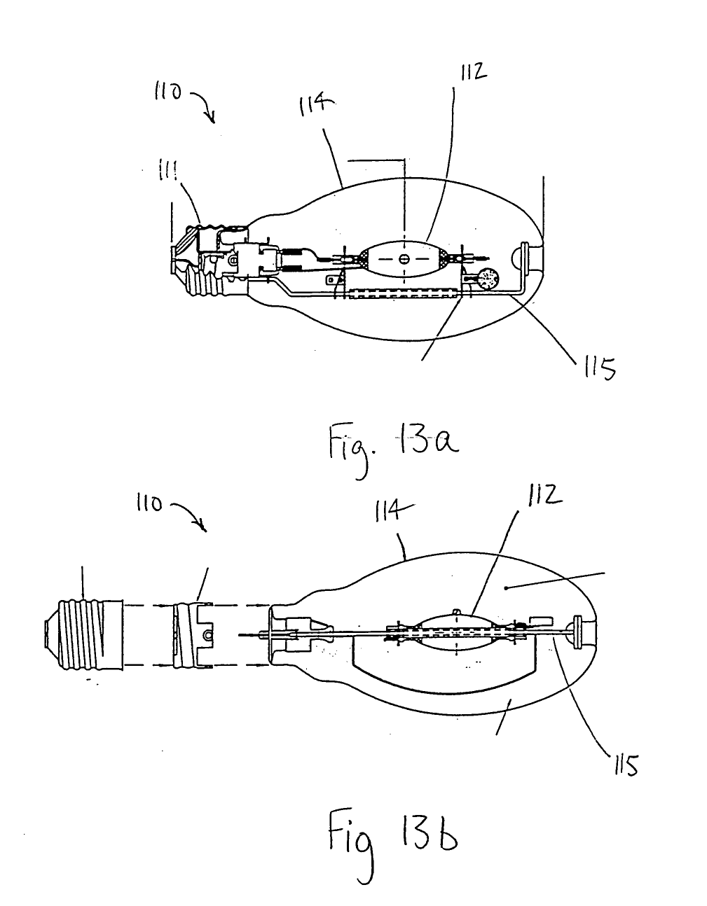

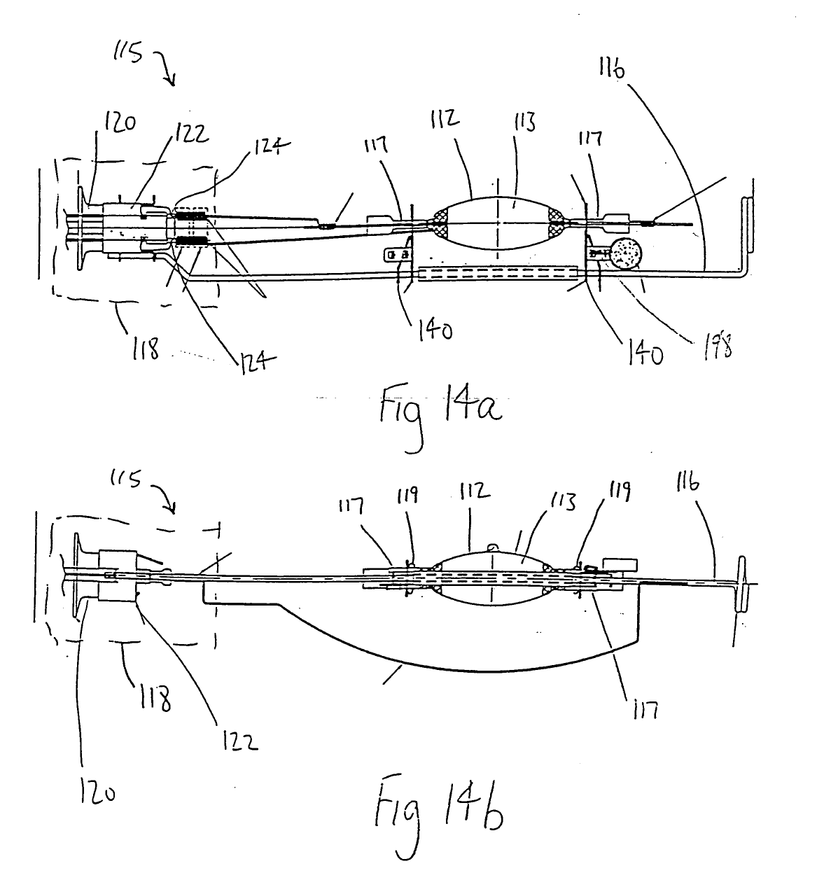

FIGS. 4a and 4b illustrate the arc tube mounting structure for the lamp illustrated in FIGS. 3a and 3b. With reference to FIGS. 4a and 4b, the mounting structure 50 comprises a frame 52 which is mechanically supported by the stem assembly 54. The stem assembly 54 comprises a stem 56 which may be formed from hard glass, a metallic stem clamp 58, and two stem leads 60 which provide an electrical coupling between the arc tube 42 supported within the outer lamp envelope (not shown) and a source of electrical power (not shown) for operating the lamp.

The frame 52 is mechanically supported at one end by the stem assembly 54. In one embodiment of the present invention, the integrity of the mechanical support of the frame 52 by the stem assembly 54 is maintained without a weld.

FIGS. 5a and 5b illustrate one embodiment of the frame according to the present invention. With reference to FIGS. 5a and 5b, the frame 52 comprises a metallic wire formed into an end portion 62 and a pair of generally parallel legs 64 extending in substantially the same direction from the end portion 62. Each leg 64 includes one or more swaged portions 66 at predetermined locations along the length thereof. FIG. 5c illustrates an enlarged cross-section of the leg 64 at a swaged portion 66 thereof.

FIGS. 6a and 6b illustrate one embodiment of the stem clamp according to the present invention. With reference to FIGS. 6a and 6b, the stem clamp 58 is a generally tubular metallic clamp which is adapted to fit over the stem 56 as illustrated in FIGS. 4a and 4b. The stem clamp 58 includes two pairs of frame retaining tabs 67, each pair having an upper tab 68 and lower tab 69 and being positioned opposite the other pair about the curved surface of the stem clamp 58. Each retaining tab 68,69 forms an aperture 70 and is adapted to receive therethrough a portion of one of the legs 64 adjacent the terminal end thereof. Each pair of frame retaining tabs 67 is aligned so that the leg 64 received therethrough is substantially parallel to the longitudinal axis 71 of the stem clamp 58.

The frame 52 may be mechanically supported by the stem assembly 54 by positioning each leg 64 through the apertures 70 formed by the upper tab 68 and the lower tab 69 of one of the pairs of retaining tabs 67. Each pair of retaining tabs 67 laterally constrains the leg 64 received therethrough. With further reference to FIG. 3a, the rigid attachment between the outer lamp envelope 44 and the lamp base 41 axially constrains the mounting structure 50 supported therein. The integrity of the mechanical support of the frame 52 by the stem assembly 54 is maintained by axial constraint of the frame 52 after the terminal ends thereof are received through the pairs of retaining tabs 67. Thus the integrity of the mechanical support of the frame 52 from the stem assembly 54 may include no welds.

With further reference to FIGS. 4a, 4b, 5a and 5b, the arc tube 42 and the shroud 44 may be mechanically supported at each end by a shroud cap 76. Each shroud cap 76 is mechanically supported by the frame 52. In one embodiment of the present invention, the integrity of the mechanical support of one or both shroud caps 76 is maintained without a weld.

FIG. 7 illustrates a shroud-cap of one embodiment of the present invention. With reference to FIG. 7, the shroud cap 76 is a generally planar member having a generally circular shape and comprises one or more shroud retaining tabs 78 positioned about the circumference thereof, two frame retaining tabs 80 each positioned opposite the other about the circumference thereof, and a central arc tube retaining tab 82 positioned at or about the center thereof.

Each frame receiving tab 80 forms a slot 81 which is adapted to receive therein a swaged portion 66 of one of the legs 64 of the frame 52. The swaged portions 66 on each leg 64 are positioned so that when received in the frame receiving tabs 80 of the shroud cap 76, the shroud cap may be mechanically supported between the legs 64 at a substantially right angle thereto. The integrity of the mechanical support may be maintained by crimping the tabs 80 about the swaged portion 66 received therein. The integrity of the mechanical support is further maintained by the lateral constraint of the terminal ends of the legs 64 by the stem assembly 54. Thus the integrity of the mechanical support of one or both of the shroud caps 76 from the frame 52 may be maintained without a weld.

The shroud 44 is a generally tubular member formed from light transmitting material. The shroud may be mechanically supported at each end by positioning the shroud 44 between each shroud cap 76 so that the longitudinal axis of the shroud 44 is substantially parallel to each leg 64. The integrity of the mechanical support of the shroud 44 between each shroud cap 76 may be maintained by bending the shroud retaining tabs 78 to be in contact with the outer surface of the shroud 44 as illustrated in FIGS. 4a and 4b.

The arc tube 42 includes a bulbous light emitting chamber 43 between two end portions 45. The arc tube 42 may be supported at each end portion 45 by the arc tube retaining tab 82 of one of the shroud caps 76. Each tab 82 forms an aperture 83 adapted to receive a portion of one end portion 45 of the arc tube 42 therethrough. The arc tube 42 is positioned between the tabs 82 of each shroud cap 76 so that the longitudinal axis of the arc tube 42 is substantially parallel to the legs 64 of the frame 52.

Each end portion 45 of the arc tube 42 includes an axial positioning portion 47 which is of larger cross-sectional dimension than the end portion 45. The cross-sectional dimension of the axial positioning portion 47 is large enough to prevent the passage of the axial positioning portion 47 through the aperture 83 of tab 82 of each shroud cap 76. The shroud caps 76 may thus be spaced apart a distance to prevent axial movement of the arc tube 42 supported therebetween.

The arc tube 42 forms the light emitting chamber of the lamp, and thus the axial positioning of the arc tube is critical in optimizing the light center of the lamp. Thus the light center of the lamp may be determined by positioning the swaged portions 66 of the legs 64 which thus determines the axial position of the shroud caps 76, which thus determines the axial position of the arc tube 42. This method of aligning the light center of the lamp eliminates the time consuming process of manually aligning the arc tube during fabrication of the lamp.

In some lamps, the radial position of the arc tube is critical to the operation of the lamp. In such lamps having formed body arc tube as illustrated in FIG. 1b, the end portions of the arc tube may terminate at the pinched region which is flattened. the cross-section of the terminal portion of the end portions of the arc tube will not rotate relative to an aperture or slot having a similar geometry if inserted therethrough. FIGS. 8a and 8b illustrate yet other embodiments of the arc tube retaining tabs according to the present invention. With reference to FIGS. 8a and 8b, the tab 84 forms an elongated aperture 85 adapted to receive the flattened end portion of an arc tube. The tab 86 forms an elongated slot 87 adapted to receive the flattened end portion of an arc tube. The dimension of the aperture 85 and slot 87 may be adapted to prevent rotation of the end portion of the arc tube received therethrough. Thus the arc tube may be radially aligned by positioning the elongated dimension of the aperture 85 or slot 87 and thus radially positioning the arc tube supported by the tabs 84,86.

Electrical Coupling:

In addition to providing mechanical support for the arc tube in HID lamps, the mounting structure provides electrical coupling of the arc tube to a source of electrical power for operating the lamp. The aspect of the present invention directed to the electrical coupling of the arc tube to a power source is suitable for any type HID lamp and may be easily understood in the embodiment for open fixture metal halide lamps.

FIGS. 9a and 9b illustrate the embodiment of the present invention illustrated in FIGS. 4a and 4b. With reference to FIGS. 9a and 9b, the mounting structure 50 includes the stem leads 60 which each provide electrical coupling between the arc tube 42 and a source of electrical power (not shown).

The arc tube 42 includes the arc tube lead 90 at one end and the arc tube lead 92 at the other end thereof. The connector 94 provides electrical coupling between the arc tube lead 90 and one of the stem leads 60. The connector 96 provides electrical coupling between the arc tube lead 92 and the other stem lead 60. In one embodiment of the present invention, the integrity of the electrical coupling between the arc tube leads 90,92 and the stem leads 60 may be maintained without welds.

FIGS. 10 and 11 each illustrate an embodiment of a connector for electrically coupling an arc tube lead to a stem lead according to the present invention. With reference to FIG. 10, the connector 94 comprises an elongated wire having a coil 100 formed at one end and a coil 102 formed at the other end thereof. The coil 100 is adapted to receive a portion adjacent the terminal end of one of the stem leads 60 therein so that the coil 100 extends axially around the portion of the stem lead 60 received therein. At least a portion of the coil 100 is crimped around the portion of the stem lead 60 received therein to establish and maintain the integrity of the electrical coupling between the connector 94 and one of the stem leads 60.

The coil 102 is adapted to receive a portion adjacent the terminal end of the arc tube lead 90 therein so that the coil 102 extends axially around the portion of the arc tube lead 90 received therein. At least a portion of the coil 102 is crimped around the portion of the arc tube lead 90 received therein to establish and maintain the integrity of the electrical coupling between the connector 94 and the arc tube lead 90. Thus the integrity of the electrical coupling between the arc tube lead 90 and one of the stem leads 60 may be maintained without a weld.

With reference to FIG. 11, the connector 96 comprises an elongated wire, commonly referred to as a flywire, having a coil 104 formed at one end and a coil 106 formed at the other end thereof. The coil 104 is adapted to receive a portion adjacent the terminal end of one of the stem leads 60 therein so that the coil 104 extends axially around the portion of the stem lead 60 received therein. At least a portion of the coil 104 is crimped around the portion of the stem lead 60 received therein to establish and maintain the integrity of the electrical coupling between the connector 96 and one of the stem leads 60.

The coil 106 is adapted to receive a portion adjacent the terminal end of the arc tube lead 92 therein so that the coil 106 extends axially around the portion of the arc tube lead 92 received therein. At least a portion of the coil 106 is crimped around the portion of the arc tube lead 92 received therein to establish and maintain the integrity of the electrical coupling between the connector 96 and the arc tube lead 92. Thus the integrity of the electrical coupling between the arc tube lead 92 and one of the stem leads 60 may be maintained without a weld.

In the fabrication of lamps, the stem is susceptible to breakage due to its relative fragility. In the event that the stem must be replaced after the connectors 94,96 and the stem leads 60 have been electrically coupled, such electrical coupling must be suitable for uncoupling and recoupling the connectors with a new stem and stem leads. FIG. 12 illustrates an embodiment of the electrical coupling between the arc tube leads and the stem leads which is suitable for recoupling the leads. With reference to FIG. 12, the electrical coupling between the stem leads 60 and the connectors 94,96 is established and maintained by crimping only a portion 101 of the coil 100 and a portion 105 of the coil 104 sufficient to establish and maintain such electrical coupling. In the event that the crimped portions 101,105 must be removed from the connector 94,96 to uncouple the connectors 94,96 from the stem leads 60, the uncrimped portion 103 of the coil 100 and portion 107 of the coil 104 are of sufficient length so that the electrical coupling between the connectors 94,96 may be reestablished and maintained by crimping portions 103,107. Thus the arc tube 42 may be electrically uncoupled and recoupled to the stem leads 60.

Enclosed Fixture Lamps:

FIGS. 13a and 13b illustrate a 350 watt enclosed fixture (i.e. unshrouded) metal halide lamp. With reference to FIGS. 13a and 13b, the lamp 110 includes a formed body arc tube 112 which is mechanically supported and electrically coupled within the outer lamp envelope 114 by the mounting structure 115.

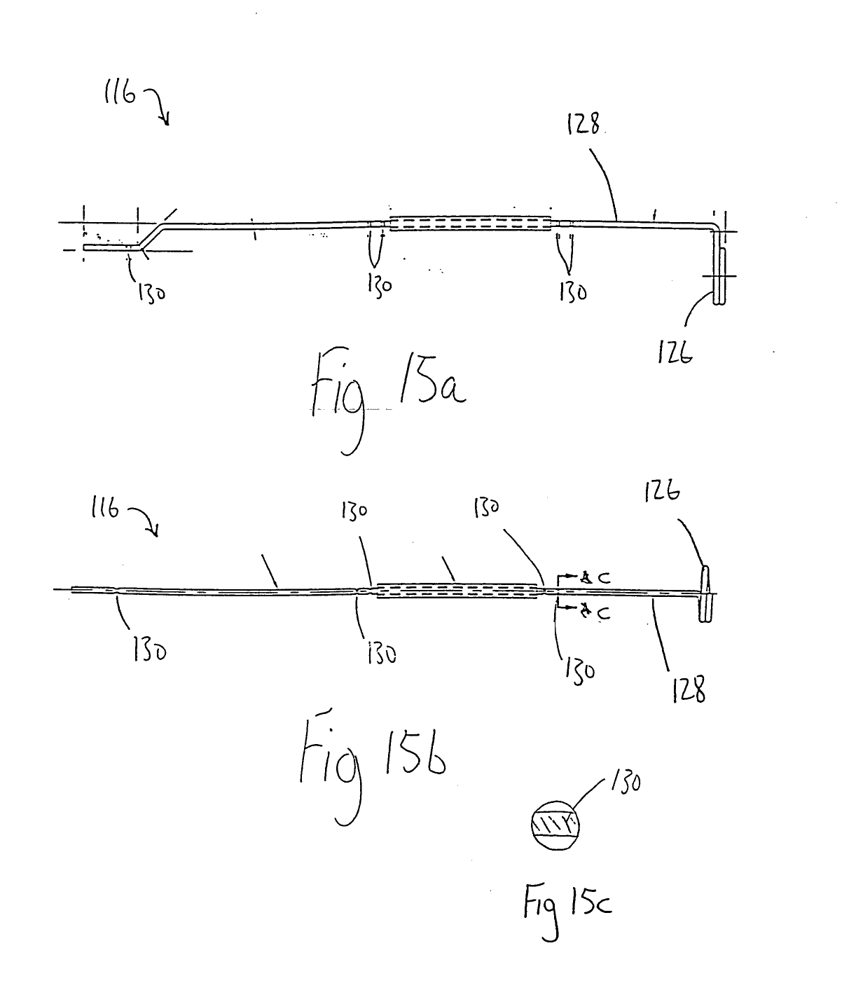

FIGS. 14a and 14b illustrate the arc tube mounting structure for the lamp illustrated in FIGS. 13a and 13b. With reference to FIGS. 14a and 14b, the mounting structure 115 comprises a frame 116 which is mechanically supported by the stem assembly 118. The stem assembly 118 comprises a stem 120 which may be formed from hard glass, a metallic stem clamp 122, and two stem leads 124 which provide electrical coupling between the arc tube 112 supported within the outer lamp envelope (not shown) to a source of electrical power (not shown) for operating the lamp.

The frame 116 is mechanically supported at one end by the stem assembly 118. In one embodiment of the present invention, the integrity of the mechanical support of the frame 116 by the stem assembly 118 is maintained without a weld.

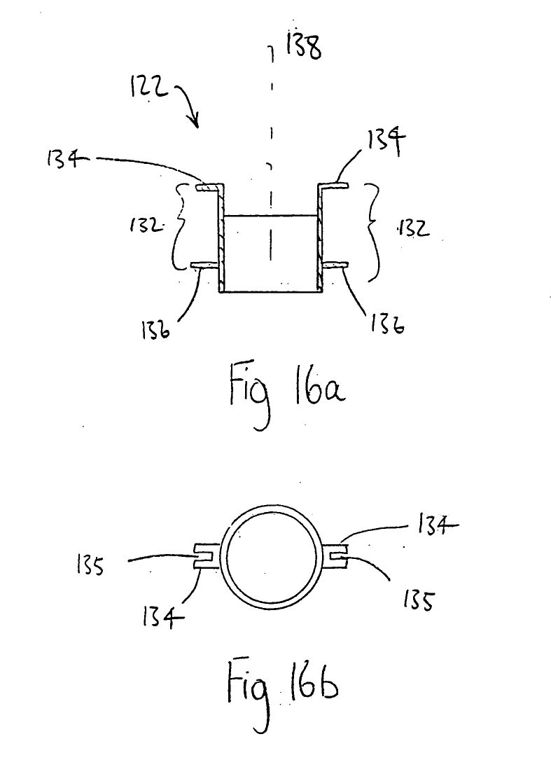

FIGS. 15a and 15b illustrate one embodiment of the frame according to the present invention. With reference to FIGS. 15a and 15b, the frame 116 comprises a metallic wire formed into an end portion 126 and an leg 128 extending therefrom. The leg 128 includes one or more swaged portions 130 at predetermined locations along the length thereof. FIG. 115c illustrates an enlarged cross-section of the leg 128 at a swaged portion 130 thereof.

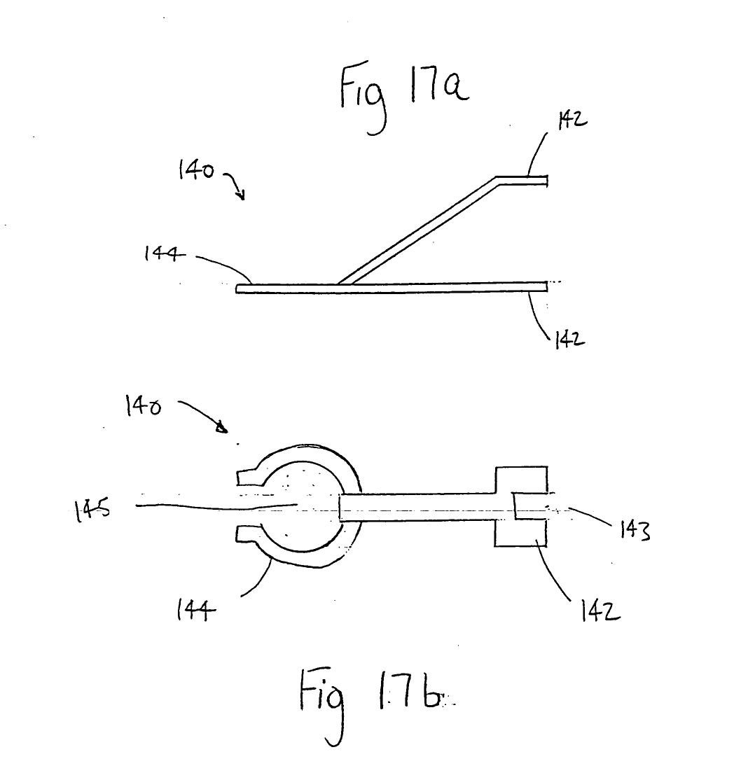

FIGS. 16a and 16b illustrate one embodiment of the present invention suitable for mechanically supporting the frame in an enclosed fixture lamp. With reference to FIGS. 16a and 16b, the stem clamp 122 includes two pairs of frame retaining tabs 132, each pair having an upper tab 134 and a lower tab 136 and being positioned opposite the other pair about the curved surface of the stem clamp 122. Each of the lower retaining tabs 136 forms an aperture (not shown) and is adapted to receive the terminal end of the leg 128 of the frame 116 therethrough. Each of the upper tabs 134 forms a slot 135 which is adapted to receive a swaged portion 130 of the leg 128 therein. Each pair of frame retaining tabs 132 is aligned so that the leg 128 received therethrough is substantially parallel to the longitudinal axis 138 of the stem clamp 122. Because there is only one leg 128 of frame 116, only one pair of retaining tabs 132 is needed to support the frame 116. Also because there is only one leg 128, the frame 116 is susceptible to radial movement about the axis of the leg 128. Thus the slot 135 must also be adapted to constrain such radial movement of the frame 116 by preventing rotation of the swaged portion 130 received therein.

The frame 116 may be mechanically supported by the stem assembly 118 by positioning the terminal end of the leg 128 through the aperture formed by the lower tab 136 and positioning the swaged portion 130 nearest the terminal end of the leg 128 into the slot 135 formed by the corresponding upper tab 134. The tabs 134,136 laterally constrain the terminal end of the leg 128. The integrity of the mechanical support may be maintained by crimping the upper tabs 134 about the portion of the leg 128 received therein.

With further reference to FIG. 13a, the rigid connection between the outer lamp envelope 114 and the lamp base 111 axially constrains the mounting structure 115 and thus the frame 116 supported therein. Thus the integrity of the mechanical support is further maintained by the axial constraint of the frame 116 and may include no welds.

With further reference to FIGS. 14a, 14b, 15a and 15b, the arc tube 112 may be mechanically supported at each end by an arc tube clip 140. Each arc tube clip 140 is mechanically supported by the frame 116. In one embodiment of the present invention, the integrity of the mechanical support of one or both arc tube clips 140 may be maintained without a weld.

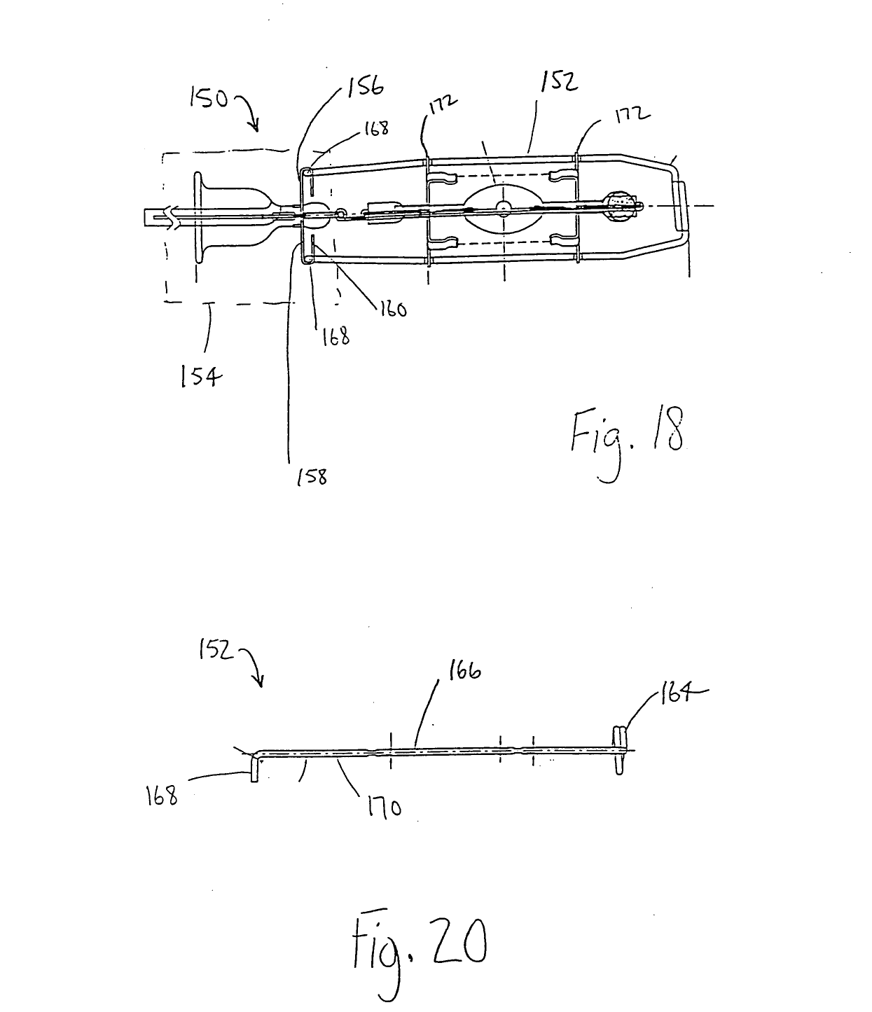

FIGS. 17a and 17b illustrate an arc tube clip of one embodiment of the present invention. With reference to FIGS. 17a and 17b, the arc tube clip 140 is a substantially rigid member comprising a pair of frame receiving tabs 142 at one end and an arc tube receiving tab 144 at the other end thereof.

Each frame receiving tab 142 forms a slot 143 which is adapted to receive therein a swaged portion 130 of the leg 128 of the frame 116. The integrity of the mechanical support of the arc tube clips 140 may be maintained by crimping the tabs 142 about the swaged portion 130 received therein. Thus the integrity of the mechanical support of one or both of the arc tube clips 140 from the frame 116 may be maintained without a weld.

With further reference to FIGS. 14a and 14b, the arc tube 112 includes a bulbous light emitting chamber 113 between two end portions 117. The arc tube 112 may be supported at each end portion 117 by the arc tube retaining tab 144 of one of the arc tube clips 140. Each tab 144 forms a slot 145 adapted to receive a portion of one end portion 117 of the arc tube 112 therethrough. The arc tube 112 is positioned between the tabs 144 of each arc tube clip 140 so that the longitudinal axis of the arc tube 112 is substantially parallel to the leg 128 of the frame 116.

Each end portion 117 may include an axial positioning portion 119 which is of larger cross-sectional dimension than the end portion 117. The cross-sectional dimension of portions 119 is large enough the prevent the passage of portions 119 through the slots 145. Thus the arc tube clips 140 may be spaced apart a distance to prevent axial movement of the arc tube 112 supported therebetween.

The light center of the lamp 110 may be determined by positioning the swaged portions 130 along the length of the leg 128.

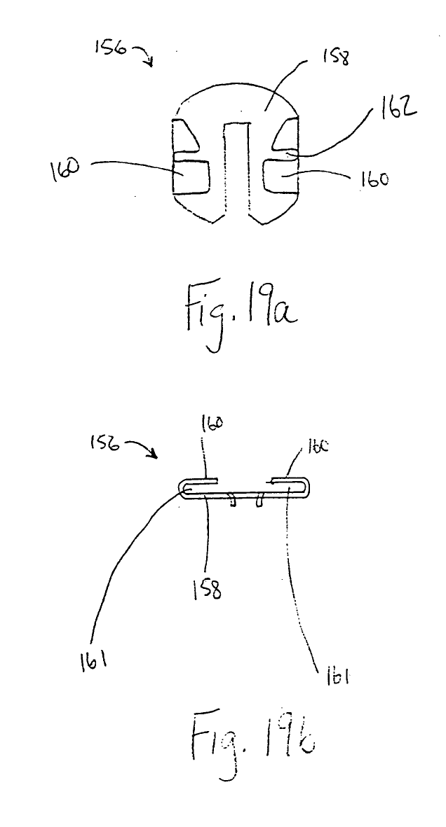

Metal halide lamps of lower wattage (i.e. about 150 W and below) typically include a medium type base. FIG. 18 illustrates a mounting structure for a metal halide lamp having a medium type base. With reference to FIG. 18, the mounting structure 150 includes a frame 152 and a stem assembly 154 comprising a heat shield 156. The frame 152 is mechanically supported by the heat shield 156.

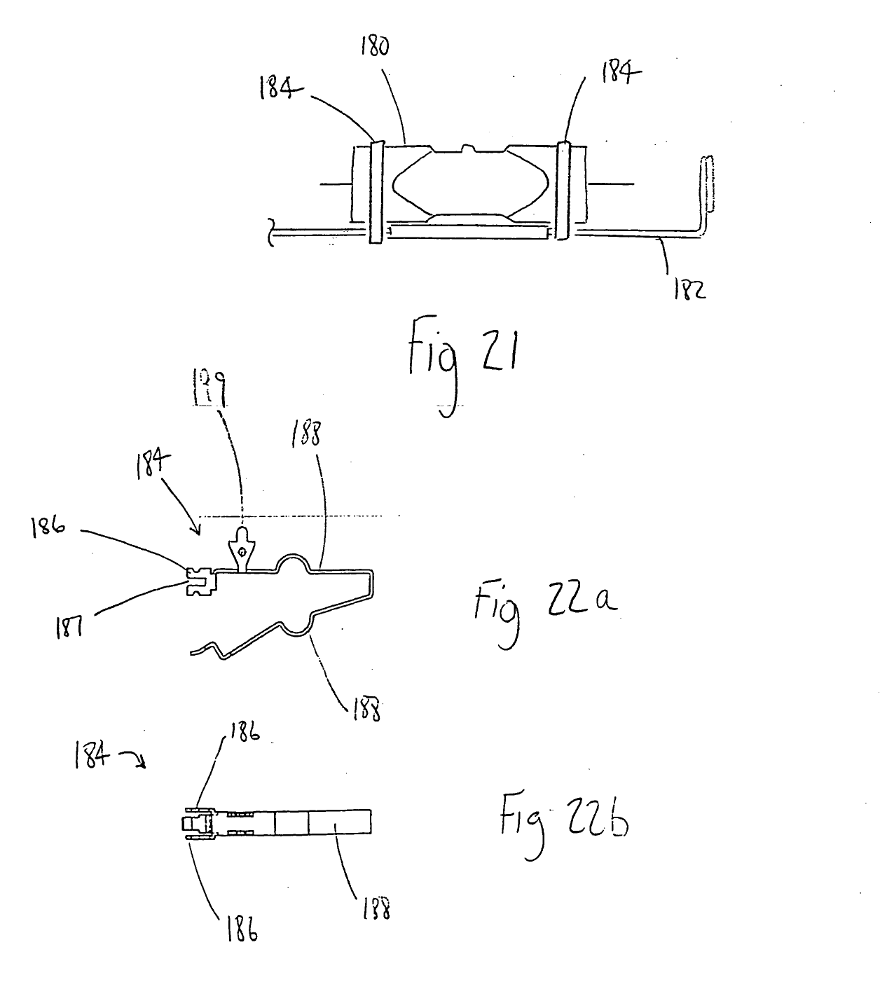

FIGS. 19a and 19b illustrate one embodiment of the heat shield according to the present invention. With reference to FIGS. 19a and 19b, the heat shield 156 comprises a generally planar shield portion 158 and a pair of frame retaining tabs 160 positioned on opposites sides of the shield portion 158. Each of the retaining tabs 160 overlies a portion of the shield portion 158 forming a gap 161. Each of the retaining tabs 160 also forms a slot 162.

FIG. 20 illustrates the frame 152. With reference to FIG. 20, the frame 152 comprises a wire formed into and end portion 164 and a pair of substantially parallel legs 166 extending in the same direction from the end portion 164. Each leg 166 terminates in a terminal portion 168 extending at a substantially right angle from the major portion 170 of the leg 166.

Each of the slots 162 is adapted to receive one of the legs 166 therein at the portion of the leg 166 adjacent the terminal portion 168. Each of the gaps 161 is adapted to receive therein the terminal portion 168 of the leg 166 received in the adjacent slot 162. The tabs 160 may be crimped to retain the terminal portions 168 received in the gaps 161.

With further reference to FIG. 18, the shroud cap 172 has a dimension normal to the legs 166 which is larger than the corresponding dimension of the heat shield 156. Thus the terminal portions 168 of the legs 166 are compressed toward the each other when received within the gaps 161 formed in the heat shield 156. The crimping of the tabs 160 about the terminal portions 168 received therein maintains the integrity of the mechanical support of the frame 152 by the stem assembly 154 without a weld. The mechanical support is further enhanced by the resistance of the legs 166 to the compression of the terminal portions, as well as the frictional engagement between the heat shield 156 and the legs 166 received therein. In some embodiments, crimping of the tabs 160 may not be necessary.

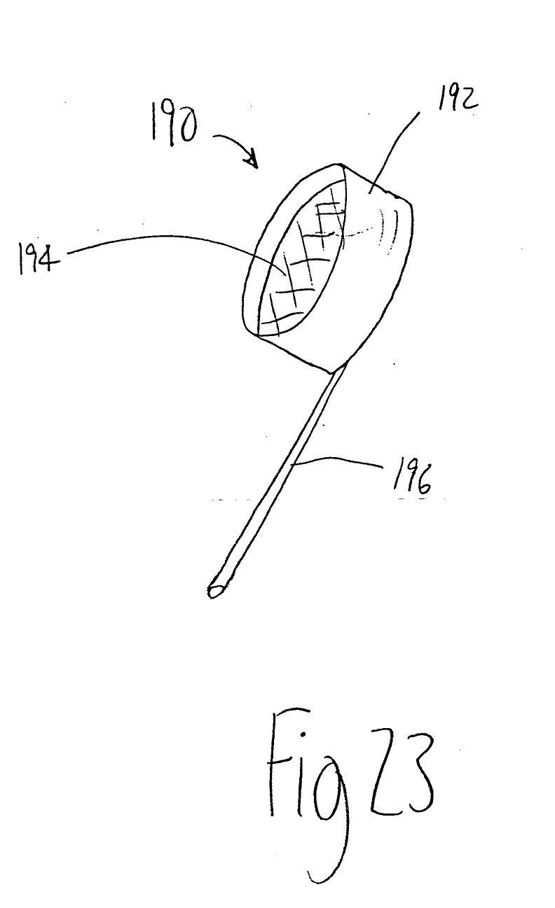

The present invention is suitable for supporting pinched body arc tube as well as formed body arc tubes. FIG. 21 illustrates one embodiment of the present invention suitable for supporting a pinched body arc tube. With reference to FIG. 21, the arc tube 180 is supported at each end from the frame 182 by an arc tube clip 184. FIGS. 22a and 22b illustrate one embodiment of the arc tube clip suitable for supporting a pinched body arc tube from the frame. With reference to FIGS. 22a and 22b, the arc tube clip 184 includes a pair of frame retaining tabs 186 at one end. Each frame retaining tab 186 forms a slot 187 adapted to receive a swaged portion of the frame 182 therein. The tabs 186 may be crimped to maintain the integrity of the mechanical support of the arc tube clip 184 from the frame 182.

The arc tube clip 184 further includes a pair of arc tube clamping portions 188 adapted to receive one pinched end of the arc tube 180 therebetween. The pinched end of the arc tube may be retained between the clamping portions 188 by compressing the clamping portions 188 around the pinched end of the arc tube and securing the tab 189 behind the frame received in the slots 187 formed by the frame retaining tabs 186.

In many HID lamps it is desirable to getter excess gasses such as hydrogen and oxygen from within the outer lamp envelope. Typically a getter material is mounted within the outer lamp envelope by welding a getter cap to the lamp mounting structure. In yet another aspect of the present invention, the getter cap may be supported within the outer lamp envelope with no welds between the getter cap and the mounting structure.

FIG. 23 illustrates a typical getter cap. With reference to FIG. 23, the getter cap 190 comprises a getter containing portion 192 which contains the getter material 194. A getter cap mounting wire 196 is typically attached at one end to the getter containing portion 192 by a weld. The getter cap 190 is typically supported by a lamp mounting structure by welding the other end to the mounting wire 196 to the structure. In one embodiment of the present invention, the getter cap 190 may be supported from the lamp mount by providing a getter mount tab such as tabs 197,198,199 illustrated in FIGS. 9a, 14a, and 22a respectively, feeding the distal end of the mounting wire 196 through one or more apertures formed by the tab 197 or tab 198 or tab 199, and wrapping the end of the wire 196 around a portion of the tab. Thus the getter cap may be supported by the mounting structure without a weld between the getter cap and the structure.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof.

1. In a high intensity discharge lamp having an arc tube supported within the outer lamp envelope wherein one or more arc tube leads are electrically coupled to a lamp base adapted to receive electrical power from an external power source, the improvement wherein the electrical coupling between at least one of the arc tube leads and the lamp base includes no welds.

2. The HID lamp of claim 1 wherein the electrical coupling between each of the arc tube leads and the lamp base includes no welds.

3. The HID lamp of claim 1 wherein the electrical coupling between at least one of the arc tube leads and the lamp base comprises an elongated wire forming a coil adjacent one or both ends thereof.

4. The HID lamp of claim 3 wherein a portion of one of said arc tube leads is received within at least a portion of one of said coils so that said portion of the coil extends axially around said portion of the arc tube lead, whereby at least a section of said portion of the coil is crimped around the arc tube lead to enhance the integrity of the electrical coupling between said wire and said arc tube lead.

5. The HID lamp of claim 3 wherein the lamp base is electrically coupled to at least one stem lead having a portion thereof received within at least a portion of one of said coils so that said portion of the coil extends axially around said portion of the stem lead, whereby at least a section of said portion of the coil is crimped around the stem lead to enhance the integrity of the electrical coupling between said wire and said stem lead.

6. The HID lamp of claim 5 wherein a portion of one of said arc tube leads is received within at least a portion of one of said coils so that said portion of the coil extends axially around said portion of the arc tube lead, whereby at least a section of said portion of the coil is crimped around the arc tube lead to enhance the integrity of the electrical coupling between said wire and said arc tube lead.

7. The HID lamp of claim 3 wherein said wire forms a coil adjacent both ends thereof, a portion of one of said arc tube leads being received within at least a portion of one of said coils so that said portion of the coil extends axially around said portion of the arc tube lead, the lamp base being electrically coupled to at least one stem lead having a portion thereof received within at least a portion of the other of said coils so that said portion of the coil extends axially around said portion of the stem lead, whereby at least a section of said portions of said coils is crimped around the lead received therein to enhance the integrity of the electrical coupling between said wire and said leads.

8. In a high intensity discharge lamp including an outer lamp envelope having an arc tube mounted therein and one or more electrical connections for operating the arc tube, the improvement wherein one or more of the electrical connections are weldless.

9. In a high intensity discharge lamp including an arc tube having one or more leads electrically coupled to an electrical power receiving lamp base, the improvement wherein the electrical coupling between at least one of the arc tube leads and the lamp base comprises an elongated wire forming a coil adjacent one or both ends thereof.

10. The HID lamp of claim 9 wherein said wire forms a coil adjacent both ends thereof.

11. The HID lamp of claim 9 wherein said coil is adapted to receive therein a portion of one of said arc tube leads so that at least a portion of said coil extends axially around the portion of the arc tube lead received therein, at least a section of said portion of said coil being crimped around the arc tube lead.

12. The HID lamp of claim 9 wherein said base comprises one or more stem leads, said coil being adapted to receive therein a portion of one of said stem leads so that at least a portion of said coil extends axially around the portion of the stem lead received therein, at least a section of said portion of said coil being crimped around the stem lead.

13. The HID lamp of claim 12 wherein said wire terminates in a coil at both ends, said other coil being adapted to receive therein a portion of one of said arc tube leads so that at least a portion of said coil extends axially around the portion of the arc tube lead received therein, at least a section of said portion of said coil being crimped around the arc tube lead.

14. The HID lamp of claim 12 wherein said coil comprises an uncrimped portion adjacent the uncoiled portion of the wire forming said coil.

15. The HID lamp of claim 14 wherein said uncrimped portion comprises about one half of the coil.

16. The HID lamp of claim 9 further comprising a plurality of wires and a pair of stem leads, each stem lead being electrically coupled to said base and having at least a portion of a coil of one of said wires crimped around a portion thereof.

17. The HID lamp of claim 16 further comprising a plurality of wires and a pair of stem leads, each stem lead being electrically coupled to said base and having at least a portion of a coil of one of said wires crimped around a portion thereof, the other end of each of said wires forming a coil being at least partially crimped around a portion of one of said arc tube leads.

18. The HID lamp of claim 9 further comprising a plurality of wires, wherein each arc tube lead includes a portion thereof having at least a portion of a coil of one of said wires crimped therearound.

19. The HID lamp of claim 9 further comprising a plurality of wires wherein at least a portion of a coil formed in one of said wires is crimped around at least a portion of a coil formed in one or more of the other wires.

20. The HID lamp of claim 9 further comprising a frame.

21. An HID lamp comprising:
a. an outer lamp envelope having an opening at one end;
b. an arc tube mounted within said outer lamp envelope; and
c. a mounting structure for supporting said arc tube and providing weldless electrical coupling between the arc tube and a source of electrical power, said mounting structure comprising:
i. a stem assembly mounted at the open end of said lamp envelope, said stem assembly including a stem and first and second stem leads each providing an electrical connection from the interior of the lamp envelope to the exterior of the lamp envelope;
ii. an elongated frame supported at one end by said stem assembly;
iii. a first arc tube clip supported by said frame, said first arc tube clip supporting the end of the arc tube nearer the stem assembly;
iv. a second arc tube clip supported by said frame, said second arc tube clip supporting the other end of the arc tube;
v. a first electrical connector electrically coupling the first stem lead to a first arc tube lead; and
vi. a second electrical connector electrically coupling the second stem lead to a second arc tube lead.

22. The HID lamp of claim 21 wherein said first and second electrical connectors comprises an elongated electrically conducting wire forming a coil adjacent each end thereof, one of said coils of each of said connectors being adapted to receive a portion of one of the stem leads therein, the other of said coils of each of said connectors being adapted to receive a portion of one of said arc tube leads therein, at least a portion of each coil being crimped around the lead received therein.

23. The HID lamp of claim 22 wherein each coil having a portion of a stem lead received therein comprises an uncrimped portion adjacent the uncoiled portion of the wire forming said coil.

24. The HID lamp of claim 21 wherein said mounting structure includes no weld between said frame and said stem assembly.

25. The HID lamp of claim 21 wherein said mounting structure includes no weld between said frame and said first or second arc tube clip.

26. An HID lamp comprising:
a. an outer lamp envelope having an opening at one end;
b. an arc tube mounted within said outer lamp envelope;
c. a generally tubular shroud surrounding at least a portion of said arc tube; and
d. a mounting structure for supporting said arc tube and providing weldless electrical coupling between the arc tube and a source of electrical power, said mounting structure comprising:
i. a stem assembly mounted at the open end of said lamp envelope, said stem assembly including a stem and first and second stem leads each providing an electrical connection from the interior of the lamp envelope to the exterior of the lamp envelope;
ii. an elongated frame supported at one end by said stem assembly;
iii. a first shroud cap supported by said frame, said first shroud cap supporting the end of the arc tube and shroud nearer the stem assembly;
iv. a second shroud cap supported by said frame, said second shroud cap supporting the other end of the arc tube and shroud;
v. a first electrical connector electrically coupling the first stem lead to a first arc tube lead; and
vi. a second electrical connector electrically coupling the second stem lead to a second arc tube lead.

27. The HID lamp of claim 26 wherein said first and second electrical connectors comprises an elongated electrically conducting wire forming a coil adjacent each end thereof, one of said coils of each of said connectors being adapted to receive a portion of one of the stem leads therein, the other of said coils of each of said connectors being adapted to receive a portion of one of said arc tube leads therein, at least a portion of each coil being crimped around the lead received therein.

28. The HID lamp of claim 27 wherein each coil having a portion of a stem lead received therein comprises an uncrimped portion adjacent the uncoiled portion of the wire forming said coil.

29. The HID lamp of claim 26 wherein said mounting structure includes no weld between said frame and said stem assembly.

30. The HID lamp of claim 26 wherein said mounting structure includes no weld between said frame and said first or second shroud cap.

31-72. (canceled)

73. An HID lamp comprising:
a. an outer lamp envelope having an opening at one end;
b. an arc tube mounted within said outer lamp envelope;
c. a generally tubular shroud surrounding at least a portion of said arc tube; and
d. a mounting structure for supporting said arc tube and providing electrical coupling between the arc tube and an electrical power receiving lamp base, said mounting structure comprising:
i. a stem assembly mounted at the open end of said lamp envelope, said stem assembly including a stem and first and second stem leads each providing an electrical connection from the interior of the lamp envelope to the exterior of the lamp envelope;
ii. an elongated frame weldlessly supported at one end by said stem assembly;
iii. a first shroud cap weldlessly supported by said frame, said first shroud cap supporting the end of the arc tube and shroud nearer the stem assembly,
iv. a second shroud cap weldlessly supported by said frame, said second shroud cap supporting the other end of the arc tube and shroud;
v. a first electrical connector electrically coupling the first stem lead to a first arc tube lead; and
vi. a second electrical connector electrically coupling the second stem lead to a second arc tube lead.

74. The HID lamp of claim 73 wherein the electrical coupling between said arc tube and the electrical power receiving lamp base includes no welds.

75. An HID lamp comprising:
a. an outer lamp envelope having an opening at one end;
b. an arc tube mounted within said outer lamp envelope;
c. a generally tubular shroud surrounding at least a portion of said arc tube; and
d. a mounting structure for supporting said arc tube and said shroud and providing electrical coupling between the arc tube and an electrical power receiving lamp base, said mounting structure comprising:
i. a stem assembly mounted at the open end of said lamp envelope, said stem assembly including a stem and stem clamp, said stem clamp comprising two pair of frame retaining tabs each forming an aperture;
ii. an elongated frame comprising a pair of substantially parallel legs, a portion of each leg adjacent the terminal end thereof being received through the apertures formed by one pair of said frame retaining tabs, each leg having swaged portions along the length thereof;
iii. a pair of shroud caps supported by said frame, each of said shroud caps comprising a pair of frame retaining tabs, each of said tabs forming a slot, one of said tabs retaining in the slot formed thereby a swaged portion of one of said legs, the other of said tabs retaining in the slot formed thereby a swaged portion of the other of said legs, the pair of said shroud caps supporting said arc tube and said shroud therebetween.

76. An HID lamp comprising:
a. an outer lamp envelope having an opening at one end;
b. an arc tube mounted within said outer lamp envelope; and
c. a mounting structure for supporting said arc tube and providing electrical coupling between the arc tube and an electrical power receiving lamp base, said mounting structure comprising:
i. a stem assembly mounted at the open end of said lamp envelope, said stem assembly including a stem and first and second stem leads each providing an electrical connection from the interior of the lamp envelope to the exterior of the lamp envelope;
ii. an elongated frame weldlessly supported at one end by said stem assembly;
iii. a first arc tube clip weldlessly supported by said frame, said first arc tube clip supporting the end of the arc tube nearer the stem assembly;
iv. a second arc tube clip weldlessly supported by said frame, said second arc tube clip supporting the other end of the arc tube;
v. a first electrical connector electrically coupling the first stem lead to a first arc tube lead; and
vi. a second electrical connector electrically coupling the second stem lead to a second arc tube lead.

77. The HID lamp of claim 76 wherein the electrical coupling between said arc tube and the electrical power receiving lamp base includes no welds.

78. An HID lamp comprising:
a. an outer lamp envelope having an opening at one end;
b. an arc tube mounted within said outer lamp envelope; and
c. a mounting structure for supporting said arc tube and providing electrical coupling between the arc tube and an electrical power receiving lamp base, said mounting structure comprising:
i. a stem assembly mounted at the open end of said lamp envelope, said stem assembly including a stem and stem clamp, said stem clamp comprising a pair of frame retaining tabs, one tab forming an aperture and the other tab forming a slot;
ii. an elongated frame comprising a leg having swaged portions along the length thereof, said aperture receiving therethrough a portion of the leg, said slot retainably receiving therein a swaged portion of said leg;
iii. a pair of arc tube clips supported by said frame, each of said arc tube clips comprising a pair of frame retaining tabs, each of said tabs forming a slot retaining therein a swaged portion of said leg, the pair of said arc tube clips supporting said arc tube therebetween.

79-80. (canceled)
